(19) United States
(12) Patent Application Publication
(10) Pub. No.: US 2016/0219914 A1
(43) Pub. Date: Aug. 4, 2016

(54) Oil acid value neutralization/sterilization

(71) Applicant: Tieh-Chun Tang, Rowland Heights, CA (US)

(72) Inventor: Tieh-Chun Tang, Rowland Heights, CA (US)

(21) Appl. No.: 14/545,360

(22) Filed: Apr. 27, 2015

(30) Foreign Application Priority Data
Jan. 31, 2015 (CN) 201510049259X

(51) Int. Cl. A23L 1/304

(52) U.S. Cl. CPC A23L 1/304; A23V 2002/00

(57) ABSTRACT

The invention relates to acid neutralizer technology, and more specifically to an oil acid value neutralization and sterilization calcium formula, including by weight:

Calcium carbonate 0.5-1.5 parts, mineral powder 7-12 parts, calcium supplements 18-22 parts, silica 8-12 parts, far infrared powder 22-28 parts, anion powder 23-27 parts, silicon potting compound 8-12 parts.

The invention of a oil acid value neutralization and sterilization formula, to neutralize cooking oil acid value, and removal of aflatoxin, kill the bacteria in the cooking oil, ensure the health and safety of edible oil, supplement the human body needs calcium and mineral elements, improve human disease resistance, anti-aging, improve human body function.

### TECHNICAL FIELD

The invention relates to acid neutralizer technology, specific involves an oil acid value neutralization and sterilization calcium formula.

### BACKGROUND

Near the end of the 20th century, more and more people realized the importance of pH balance to the human body, a healthy body should show alkaline, such as pH value of 7.5 instead of acid. Therefore, how to balance the body pH became the latest and the most popular trends in today's society, at the same time, human and a sharp rise in demand for health products.

Acidic mixtures in our daily life, such as oil additives, food additives, detergents, germicide and disinfectant, etc., these acid mixture can damage human body, also can produce dioxin pollution environment. Such as the material as a food additive used in animal husbandry, fishery and other industrial products. Sulfaguanidine and kappa number and so on synthesis of antibacterial agent for human skin and hair care or as drugs for human and animals. However, from the safety of food and drugs, some of the material should be under strict control, especially the acid value is lower than the standard values of the material.

Cooking oil is not safe when available raw materials aren't safe. Genetically modified soy beans, high levels of pesticide residues in corn, hormones, preservative, beans, metamorphism, such as carcinogenic aflatoxin; and naked eye can not see the terror in cooking oil, acid value is higher than the standard values for the human body, its existence of the existence of implicit acid value or aflatoxin, a variety of bacteria and hidden, consumer can be in imperceptible in using this kind of cooking oil, chemical imbalance value high acid in the human body, this will lead to advance of human aging, listless, all kinds of bacteria can also lead to chronic diseases, serious impact on human health.

### SUMMARY OF THE INVENTION

In order to overcome the shortcomings of existing technology, the aim of the present invention is to provide neutralization and sterilization of all cooking oils having acid values and bacteria, to remove aflatoxin, kill the bacteria in the cooking oil, ensure the health and safety of edible oil, and add the required elements of the human body, oil acid value and improve the function of the body. This problem occurs in all popular types of cooking oils, including canola oil, soybean oil and other vegetable oils.

The aim of the present invention by the following technical scheme: a oil acid value neutralization and sterilization calcium formula, including by weight as follows:
calcium carbonate, 0.5-1.5 parts
mineral powder 7-12 parts
calcium supplements 18 -22 parts
silica 8 -12 parts
far infrared powder 22-28 parts
negative ion powder 23-27 parts
silicon potting compound 8-12 parts

For premium quality, include by weight as follows:
calcium carbonate 0.8-1.2 parts
minerals powder 9-11 parts
calcium supplements 19-21 parts
silica 9-11 parts
negative ion powder 24-26 parts
far infrared powder 24-26 parts
silicon potting compound 9-11 parts
   Superior quality, including the weight of the raw materials as follows:
calcium carbonate 1 part
mineral powder 10 parts
calcium supplements 20 parts
silica 10 parts
far infrared powder 25 parts
negative ions powder 25 parts
silicon potting compound 10 parts
   Described mineral powder is made of potassium, magnesium, sodium, calcium and selenium in ionic form.
   Processed tourmaline powder is the source of material for making the far infrared powder.
   Described in the negative ion powder of raw material for electrical stone powder and the combination of lanthanide content or electrical stone powder and the combination of rare earth elements content.
   calcium supplements including weight of the raw materials as follows:
Pearl 3 -7 parts
Mother of pearl 8-12 parts
Red coral 2-3 parts
Oyster shell 20-30 parts
Clam shell 35-55 parts
Giant Clam shell 5-10.parts

Premium quality, calcium supplements including weight of the raw materials as follows:
Pearl 4-6 parts
mother-of-pearl 9-11 parts
red coral 2.2-2.8 parts
oyster shell 22 to 28 parts
clam shells 40-50 parts
Giant clam shell 6-9 parts
   Superior quality, calcium supplements including weight of the raw materials as follows:
Pearl 5 parts
mother of pearl 10 parts
red coral 2.5 parts
oyster shell 25 parts
clam shell 45 parts
giant clam shell 7.5 parts
   The preparation methods of calcium supplements, includes the following steps:

A. Cleaning: the selected raw materials, and adopt the way of high pressure sand blast remove dirt on the surface of the material

B. Primary grinding: grinding materials after cleaning into 200-400 microns particles;

C. Heat decomposition: in inert gas to heat decomposition after primary grinding particles

D. Rules of grinding: the heat decomposition after grinding particles into 30-50 microns particles

E. Nanometer lapping: after grinding particle D, grinding into 0.1 1 nm nano particles

F. Mixing: mix ratio of each raw material particles according to the weight, produce calcium supplements

Premium quality, as described in step C, the raw materials of pearl, first heat up to 400-600° C. heat decomposition of 1.5 to 2.5 h, then heat up to 800-1000° C. heating 0.5 1.5 h.
Raw materials for the mother of pearl, the first heat up to 800-1000° C. heat decomposition of 4.5 to 5.5 h, then heat up to 1700-1900° C. heat 4 to 5 h
Raw materials for the red coral, the first heat up to 1000-1200° C. heat decomposition of 6.5 to 7.5 h, then heat at 1600-1800° C. heating 4.5 -5.5 h;
Oyster shell for raw material, the first heat at 700-900° C. heat decomposition for 2 to 3 h, then heat up to 1600-1800° C. heat 1-2 h;

Raw materials for the clam shells, the first heat up to 500-700° C. heat decomposition of 2.5 to 3.5 h, then heat at 1700-1900° C. heating 1.5-2.5 h

Raw material for Giant clam shell, a first heat up to 600-800° C. heat decomposition 3-4 h, then heat up to 1800-2000° C. heating 0.8 -1.2 h.

Among them, the mentioned oil acid value neutralization and sterilization calcium are in honeycomb shape.

The beneficial effects of the present invention are:

The acid neutralization and sterilization of cooking oil. The removal of edible oil aflatoxin, to avoid the aflatoxin, the harm of human body. Potential improvement in cooking oil acid value and to material suitable for human consumption, to ensure the acid-base balance of the body.

Oil acid value neutralization and sterilization kills the bacteria in cooking oil, ensures the health and safety of edible oil, and complements the human body needs calcium and mineral elements, improve human disease resistance, anti-aging, improve human body function.

The invention of an oil acid value neutralization and sterilization calcium, calcium supplements stated using pure natural marine creatures as raw material, after processing into nanoscale small molecules, it has the characteristics of marine alkaloids, and has rich nutrition, neutralize potential bad in cooking oil acid value of material, aflatoxin to remove the oil, and calcium to the body

The present invention an oil acid value neutralization and sterilization calcium, described the preparation of calcium supplements method is simple, convenient operation and control, stable quality, high yield, can be large-scale industrial production.

In order to further understanding this invention, following are some experiments for reference.

The content of the implementation methods mentioned are not limited to this invention. An oil acid value neutralization and sterilization calcium, including the weight of the raw materials as follows:
calcium carbonate, 0.5 to 1.5 parts
mineral powder 7-12 parts
calcium supplements 18-22 parts
silica 8-12 parts
far infrared ray powder 22-28 parts
negative ions powder 23 27 parts
silicon potting compound 8-12 parts

The present invention an oil acid value neutralization and sterilization calcium, the calcium carbonate have the effect of sterilization and disinfection;

The mineral powder composition described human tissue and maintain normal physiological functions required, compensatory human body minerals;

Calcium supplements, and implicit acid value of the existence of material in cooking oil and removal of aflatoxin, and calcium supplementation on the human body. Silica has the effect of sterilization.
Far infrared powder increases water molecules activeness, improves the oxygen content of the body. The human body contain about 70% water, far infrared ray to make water molecules to produce resonance Become independent water molecules (that is, the two points in hydrogen and oxygen molecules), Can increase the oxygen content of the body, cells and restore vitality, spirit more buoyant, mind is more flexible. Thus can improve the disease resistance, anti-aging The far infrared powder can balance oil and the ph of the body, prevent the bone joint pain is caused by excessive uric acid; It also has the small molecules, have the effect of the permutation and combination

The negative ion powder in the negative ion can kill the bacteria in oil, increase the dissolved oxygen, can accelerate water molecule movement, activity of ordinary water into active water, easy to remove dirt, eliminate fatigue, increase the amount of hemoglobin in the blood, reduce blood sugar, and neutralize acid value of oil, increases the PH value, reducing blood clotting time, stimulate the body hematopoiesis function.

The silicon potting compound is mainly for glue purpose.

The invention of an oil acid value neutralization and sterilization calcium, neutralize the implicit in the cooking oil acid value of the existence of matter and removal of aflatoxin, kill the bacteria in the cooking oil, ensure the health and safety of edible oil, supplement the human body needs calcium and mineral elements, improve human disease resistance, anti-aging, improve human body function.

### EXAMPLE 1

An oil acid value neutralization and sterilization formula includes the following material ratios by weight:
calcium carbonate 0.5 part
mineral powder 7 parts
calcium supplements 18 parts
silica 8 parts
Far infrared powder 28 parts
Negative ions powder 27 parts
Silicon potting compound 8 parts

Described in this example, mineral powder as potassium, magnesium, sodium, calcium, selenium and iron combination of one or more of the powder

Far infrared powder is made of processed Tourmaline powder. The negative ion powder are made of processed tourmaline powder and lanthanide or electrical stone powder.

This example includes the following material ratios by weight:
Pearl 3 parts
Mother of pearl 8 parts
Red coral 2 parts
Oyster shell 20 parts
Clam shell 55 parts
Giant shell 5 parts

The method of preparation of calcium supplements, includes the following steps

A. cleaning: the selected raw materials, together with the method of high-pressure sandblasting remove dirt from the surfaces of the material;

B. Primary grinding : after cleaning grinding materials into 200-400 micron particles;

C. Heat decomposition in inert gas, after primary grinding particles

D. Rules of grinding: the heat decomposition after grinding particles into 30-50 micron particles;

E. Nanometer lapping after grinding particle grinding into 0.1 1 nm nano particles;

F. Mixing: mix ratio of each raw material particles according to the weight, produce calcium supplements

Described in step C, when the raw material is pearl, first heat at

400-600° C. for 1.5 to 2.5 h, then heat at 800-1000° C. for 0.5-1.5 h. Step C for mother of pearl, first heat at 800-1000° C. for 4.5 to 5.5 h, then heat at 1700-1900° C. for 4-5 h

Step C for red coral, first heat at 1000-1200° C. for 6.5 to 7.5 h, then heat at 1600-1800° C. for 4.5-5.5 h.

Step C for oyster shell, first heat at 700-900° C. for 2 to 3 h, then heat at 1600-1800° C. for 1-2 h.

Step C for clam shells, first heat at 500-700° C. for 2.5 to 3.5 h, then heat at 1700-1900° C. for 1.5-2.5 h.

Step C for giant clam shells, first heat at 600-800° C. for 3-4 h, then heat at 1800-2000° C. for 0.8-1.2 h.

For implementation of the invention in honeycomb shape, soak a cellular honeycomb structure in edible oil or use the honeycomb as cooking oil filter, The honeycomb shape increases oil interface with the formula of the invention, which enhances the rate of neutralization and sterilization.
Experiment for neutralizing acidic particles and eliminate aflatoxin in cooking oil:
(1) Detection object : the acidic particle and aflatoxin
(2) Experimental Process : Take a certain volume of cooking oil, use the oil acid value neutralization and sterilization soaking, or filter the oil before and after test. The results are shown in table 1.

TABLE 1

| | don't use acid | After using the acid |
|---|---|---|
| test item | value and calcium | value and calcium |
| PH level in the oil | 3.5 | 7.2 |
| The elimination rate of aflatoxin | 0 | 98.9% |

Can be seen from Table 1, this is a good proof of oil acid value neutralization and sterilization, not only to get rid of the aflatoxin in cooking oil, also to avoid the aflatoxin harm to human body. And to neutralize the cooking oil to PH 7.2. Suitable for human consumption, to ensure that the body acid-base balance.

In this example, the oil acid value neutralization and sterilization also killed the bacteria in the cooking oil, to ensure the health and safety of edible oil, and complement the human body needs calcium and mineral elements, improve human disease resistance, anti-aging, improve human body function.
In this example, calcium supplements using pure natural marine creatures as raw material, after processing into nanoscale particles It has the characteristics of marine alkaloids, and has rich nutrition, and neutralizes acid cooking oil, removes aflatoxin from the oil, and adds calcium to the body.

In this example, The preparation of calcium supplements method is simple, convenient operation and control, stable quality, high yield, can be large-scale industrial production.

### EXAMPLE II

An oil acid value neutralization and sterilization formula includes by weight the following ratios of materials:
calcium carbonate 1.5 parts
Mineral powder 12 parts
calcium supplement 22 parts
Silica 12 parts
Far infrared ray powder 22 parts
Negative ions powder 23 parts
Silicon potting compound 12 parts
   In this example, mineral powder are made of ionized potassium, magnesium, sodium, calcium and selenium.
   Far infrared powder are made of processed tourmaline powder.
   The anion powder raw material for electrical stone powder and the combination of lanthanide content or electrical stone powder and the combination of rare earth elements content

In this example, described in the calcium supplements include the weight of the raw material
pearl 7 parts
Mother of pearl 12 parts
Red coral in 3 parts
Oyster shell 30 parts
Clam shell 35 parts
Giant Clam shell 10 parts

The method of preparation of calcium supplements for the formula includes the following steps:

A. cleaning: the selected raw materials, together with the method of high-pressure sandblasting remove dirt from the surface of the material

B. After primary grinding: after cleaning of the raw material grinding particles into a 200-400 microns

C. Heat decomposition: in inert gas to heat decomposition after primary grinding particles

D. Rules of grinding: the heat decomposition after grinding particles into 30-50 microns particles

E. Nanometer lapping: rules after grinding particle grinding into 0.1-1 nm nano particles

F. Mixing: mix ratio of each raw material particles according to the weight, produce calcium supplements

Described in step C, raw materials of pearl, first heat up to 400-600° C. heat decomposition of 1.5 to 2.5 h, then heat up to 800-1000° C. heating 0.5 -1.5 h.

Raw materials for the mother of pearl, the first heat at 800-1000° C. heat for 4.5 to 5.5 h, then heat at 1700-1900° C. for 4 to 5 h. For step C using red coral, first heat at 1000-1200° C. for 6.5 to 7.5 h, then heat at 1600-1800° C. for 4.5-5.5 h.

For step C using oyster shell for raw material, first heat at 700-900° C. for 2 to 3 h, then heat at 1600-1800° C. for 1-2 h.
For step C using clam shells, first heat at 500-700° C. for 2.5 to 3.5 h, then heat at 1700-1900° C. for 1.5-2.5 h;
For step C using giant clam shells, first heat at 600-800° C. for 3-4 h, then heat at 1800-2000° C. for 0.8-1.2 h.

In this example, described the oil acid value neutralization and sterilization calcium in honeycomb shape, Soak the cellular structure of the acid value and calcium in edible oil or cooking oil filter, The honeycomb shape design increase oil interface, Potential bad acid in the oil price material or eliminate aflatoxin, And kill the bacteria in the cooking oil while neutralizing PH level in cooking oil and removing the aflatoxin.

### Experiment:

(1) Detection object: the acid value of material, aflatoxin

(2) experimental process: take a certain volume of edible oil, use the oil acid value neutralization and sterilization calcium soaking and filter the oil before and after testing, the results are shown in table 2.

TABLE 2

| | Don't use the acid | After using the acid |
|---|---|---|
| test item | value and calcium | value and calcium |
| PH level in the oil | 3.5 | 7.7 |
| The elimination rate of aflatoxin | 0 | 99.9% |

As can be seen from table 2, As another better implementation of the present invention, The oil acid value neutralization and sterilization calcium is also fundamental to aflatoxin in addition to cooking oil To avoid the aflatoxin harm to human And oil potential bad acid value of material and to pH 7.7, suitable for human consumption, To ensure that the body acid-base balance. In this example, the oil acid value neutralization and sterilization calcium also killed the bacteria in the cooking oil, ensure the health and safety of edible oil, and complement the human body needs calcium and mineral elements, improve human disease resistance, anti-aging, improve human body function.

In this example, calcium supplements using pure natural Marine life as raw material, After processing into nanoscale small molecules, it has the characteristics of Marine alkaloids, And has rich nutrition, Neutralize potential bad in cooking oil acid value of material, Remove the aflatoxin in cooking oil, and add calcium to the body

In this example, the simple method of preparation of calcium supplements, Convenient operation and control, Stable quality, high yield, can be large-scale industrial production

### EXAMPLE 3

An oil acid value neutralization and sterilization calcium, including the weight of the raw materials as follows:
calcium carbonate 0.8 parts
mineral powder 9 parts
calcium supplement 19 parts
Silica 9 parts
Far infrared ray powder 26 parts
Negative ions powder 26 parts
9 silicon potting compound parts

Described in this example, mineral powder as potassium, magnesium, sodium, calcium, selenium and iron combination of one or more of the powder;

Described the implementation of the case, far infrared powder is made of processed tourmaline powder;

Described in the negative ion powder materials are made of electrical stone powder and the combination of lanthanide content or electrical stone powder and the combination of rare earth elements content;

In this example, described in the calcium supplements include the weight of the raw material
Pearl 4 parts
Mother of pearl 9 parts
red coral 2.2 parts
Oyster shell 22 parts
Clam shell 50 parts
Giant clam shell 6 parts

Described the implementation of the case, the method of preparation of calcium supplements, includes the following steps:

A. Cleaning: the selected raw materials, and adopt the way of high pressure sandblast remove dirt from the surface of the material;

B. After primary grinding: cleaning of the raw material grinding particles into a 200-400 microns

C. decomposability of heating: in an inert gas Heat as to heat decomposition after primary grinding particles

D. Rules of grinding: the heat decomposition after grinding particles into 30-50 microns particles;

E. Nanometer lapping: the rules after grinding particle grinding into 0.11 nm nano particle;

F. Mixing: mix ratio of each nanometer material particles according to the weight, produce calcium supplements

Described in step C, raw materials of pearl, first heat up to 400-600° C. heat decomposition of 1.5 to 2.5 h, then heat up to 800-1000° C. heating 0.5-1.5 h.

Raw materials for the mother of pearl, the first heat up to 800-1000° C. heat decomposition of 4.5 to 5.5 h, then heat at 1700-1900° C. heat 4 to 5 h
Raw materials for the red coral, the first heat up to 1000-1200° C. heat decomposition of 6.5 to 7.5 h, then heat at 1600-1800° C. heating 4.5-5.5 h;

Oyster shell for raw material, the first heat up to 700-900° C. heat decomposition 2 to 3 h, then heat up to 1600-1800° C. heat 1-2 h;

Raw materials for the clam shells, the first heat up to 500-700° C. heat decomposition of 2.5 to 3.5 h, then heat at 1700-1900° C. heating 1.5-2.5 h

Raw materials for the giant clam shells, a first heat up to 600-800° C. heat decomposition 3-4 h, then heat up to 1800-2000° C. heating 0.8 -1.2 h.

In this example, described the oil acid value neutralization and sterilization calcium in honeycomb shape, Soak the cellular structure of the acid value and calcium in edible oil or cooking oil filter, The honeycomb shape design increase oil interface, Potential bad acid in the oil price material or eliminate aflatoxin, And kill the bacteria in the cooking oil

### (I) Neutralize the Ph Level in Cooking Oil and Eliminate the Aflatoxin Experiment

(1) Detection object: the acid value of material, aflatoxin

(2) Experimental process: take a certain volume of edible oil, use the oil acid value neutralization and sterilization calcium soaking or filter the oil before and after testing, the results as shown in table 3.

TABLE 3

| | Don't use the acid | After using the acid |
|---|---|---|
| test item | value and calcium | value and calcium |
| PH level in the oil | 3.5 | 7.3 |
| The elimination rate of aflatoxin | 0 | 99% |

As can be seen from table 3, the oil acid value neutralization and sterilization calcium basic to remove the aflatoxin in the oil, also neutralize the pH level to 7.3

In this example, the oil acid value neutralization and sterilization calcium also killed the bacteria in the cooking oil, ensure the health and safety of edible oil, and complement the human body needs calcium and mineral elements, improve human disease resistance, anti-aging, improve human body function.

In this example, calcium supplements using pure natural Marine creature as raw material, after processing into nanoscale small molecules, it has the characteristics of Marine alkaloids, and has rich nutrition, neutralize potential bad in cooking oil acid value of material, aflatoxin to remove the oil, and calcium to the body.

In this example, described the preparation of calcium supplements method is simple, convenient operation and control, stable quality, high yield, can be large-scale industrial production.

### EXAMPLE 4

An oil acid value neutralization and sterilization calcium, including the weight of the raw materials as follows:
calcium carbonate 1.3 parts
Mineral powder 11 parts
Calcium supplements 21 parts
Silica 11 parts
FarNegative ions powder 24 parts
silicon potting compound 11 parts

Described in this example, mineral powder are potassium, magnesium, sodium, calcium, selenium and iron combination of one or more of the powder

Far infrared powder is made of processed tourmaline powder.

The anion powder raw material are made of electrical stone powder and the combination of lanthanide content or electrical stone powder and the combination of rare earth elements.

In this example, described in the calcium supplements include the weight of the raw material as follows :
Pearl 4 parts
Mother of pearl 9 parts
red coral 2.2 parts
Oyster shell 22 parts
clam shell 50 parts
Giant clam shell 6 parts

The method of preparation of calcium supplements, includes the following steps

A. Cleaning: the selected raw materials, and adopt the way of high pressure sandblast remove dirt on the surface of the material

B. After primary grinding: cleaning of the raw material grinding particles into a 200-400 microns

C. decomposability of heating: in an inert gas Heat as to heat decomposition after primary grinding particles

D. Rules of grinding: the heat decomposition after grinding particles into 30-50 microns particles;

E. Nanometer lapping: the rules after grinding particle grinding into 0.11 nm nano particle;

F. Mixing: mix ratio of each raw material particles according to the weight, produce calcium supplements

Described in step C, raw materials of pearl, first heat at 400-600° C. heat decomposition of 1.5 to 2.5 h, then heat at 800-1000° C. heating 0.5 -1.5 h.

Raw materials for the mother of pearl, the first heat up to 800-1000° C. heat decomposition of 4.5 to 5.5 h, then heat at 1700-1900° C. heat 4 to 5 h

Raw materials for the red coral, the first heat up to 1000-1200° C. heat decomposition of 6.5 to 7.5 h, then heat at 1600-1800° C. heating 4.5-5.5 h;

Oyster shell for raw material, the first heat up to 700-900° C. heat decomposition 2 to 3 h, then heat up to 1600-1800° C. heat 1-2 h;

Raw materials for the clam shells, the first heat up to 500-700° C. heat decomposition of 2.5 to 3.5 h, then heat at 1700-1900° C. heating 1.5-2.5 h

Raw materials for the giant clam shells, a first heat up to 600-800° C. heat decomposition 3-4 h, then heat up to 1800-2000° C. heating 0.8-1.2 h. In this example, described the oil acid value neutralization and sterilization calcium in honeycomb shape, Soak the cellular structure of the acid value and calcium in edible oil or cooking oil filter, The honeycomb shape design to increase oil contact surface, the oil potential bad acid value of material or aflatoxin and elimination, and kill the bacteria in the cooking oil.

Neutralize the pH level and remove the aflatoxin in cooking oil experiment:

(1) the test object: acid value of material, aflatoxin;

(2) experimental process: take a certain volume of edible oil, use the oil acid value neutralization and sterilization calcium soaking or filter the oil before and after testing, the results as shown in table 4.

TABLE 4

| | Don't use the acid | After using the acid |
|---|---|---|
| test item | value and calcium | value and calcium |
| PH level in the oil | 3.5 | 7.6 |
| The elimination rate of aflatoxin | 0 | 99.7% |

As can be seen from table 4, the present invention a better implementation of the cases, The oil acid value neutralization and sterilization calcium is also fundamental to aflatoxin in addition to cooking oil, To avoid the aflatoxin harm to human body, And oil potential bad acid value of material and to pH 7.6, suitable for human consumption, To ensure that the body acid-base balance.

In this example, the oil acid value neutralization and sterilization calcium also killed the bacteria in the cooking oil, Ensure the health and safety of edible oil, And supplement the human body needs calcium and mineral elements, Improve human disease resistance, anti-aging, improve human body function.

In this example, calcium supplements using pure natural marine organismas raw material, After processing into nanoscale small molecules, it has characteristics of Marine alkaloids, And has rich nutrition, can Neutralize potential bad in cooking oil acid value of material, remove the aflatoxin in cooking oil, and calcium to the body.

In this example, described the preparation of calcium supplements method is simple, convenient operation and control, stable quality, high yield, can be large-scale industrial production

### EXAMPLE 5

An oil acid value neutralization and sterilization calcium, include the weight of the raw material
calcium carbonate 1 part
Mineral powder 10 parts
Calcium supplements 20 parts
Silica 10 part
Far infrared ray powder 25 parts
Negative ions powder 25 parts
Silicon potting compound 10 parts

Described in this example, mineral powder are made of potassium, magnesium, sodium, calcium, selenium and iron combination of one or more of the powder;

Far infrared powder is made of tourmaline powder

The negative ions powder raw material are made of electrical stone powder and the combination of lanthanide content or electrical stone powder and the combination of rare earth elements content;

In this example, described in the calcium supplements include the weight of the raw material
pearl 5 parts
mother of pearl 10 parts
red coral 2.5 parts
oyster shell 25 parts
clam shell 45 parts
giant clam shell 7.5 parts
   Described the implementation of the case, the method of preparation of calcium supplements, includes the following steps:

A, cleaning: the selected raw materials, and adopt the way of high pressure sandblasting to remove dirt from the surface of the material;

B, grinding materials after cleaning into 200-400 micron particles;

C, heat decomposition in inert gas after the primary grinding;

D. grinding after heat decomposition of the particles into 30-50 micron particles;

E. then grinding into 0.1-1.0 nanometer particle size;

F. then mixing the nanometer particles according to the desired weight ratios to yield calcium supplements.

In step C, when the raw material is pearl, first heat at 400-600° C. for 1.5 to 2.5 h, then heat at 800-1000° C. for 0.5-1.5 h.
In step C, when the raw material is mother of pearl, first heat at 800-1000° C. for 4.5 to 5.5 h, then heat at 1700-1900° C. for 4-5 h.
In step C, when the raw material is red coral, first heat at 1000-1200° C. for 6.5 to 7.5 h, then heat at 1600-1800° C. for 4.5-5.5 h.
In step C, when oyster shell is the raw material, first heat at 700-900° C. for 2 to 3 h, then heat up to 1600-1800° C. heat 1-2 h;
In step C. when the raw material is clam shells, first heat at 500-700° C. for 2.5 to 3.5 h, then heat at 1700-1900° C. for 1.5 2-0.5 h.
In step C, when the raw material is giant clam shells, first heat at 600-800° C. for 3-4 h, then heat at 1800-2000° C. for 0.8 1.2 h.
When the oil acid value neutralization and sterilization calcium formula is contained in a honeycomb structure, soak the cellular structure of the acid value and calcium in edible oil or cooking oil filter, the honeycomb shape design increases oil contact surface, the oil potential bad acid value of material or aflatoxin and eliminate, and kill the bacteria in the oil.
(1) Neutralize pH level and eliminate aflatoxin in cooking oil experiment to remove acid value of material aflatoxin.
(2) experimental process: take a certain volume of edible oil, use the oil acid value neutralization and sterilization calcium soaking or filter the oil before and after testing, the results are shown in table 5.

TABLE 5

| | Don't use the acid | After using the acid |
|---|---|---|
| test item | value and calcium | value and calcium |
| PH level in the oil | 3.5 | 7.5 |
| The elimination rate of aflatoxin | 0 | 99.9% |

As can be seen from table 5, the present invention the best example, the oil acid value neutralization and sterilization calcium also basic to aflatoxin in addition to cooking oil, To avoid the aflatoxin harm to human body, And oil potential bad acid value of material, Neutralization to pH 7.5, Suitable for human consumption, To ensure the body acid-base balance In this example, the oil acid value neutralization and sterilization calcium also killed the bacteria in the cooking oil, ensure the health and safety of edible oil, and complement the human body needs calcium and mineral elements, improve human disease resistance, anti-aging, improve human body function.

In this example, calcium supplements using pure natural Marine creatures as raw material, after processing into nanoscale small molecules, it has the characteristics of Marine alkaloids, and has rich nutrition, neutralize potential bad in cooking oil acid value of material, aflatoxin to remove the oil, and calcium to the body.
In this example, described the preparation of calcium supplements method is simple, convenient operation and control, stable quality, high yield, can be large-scale industrial production.
In the above example of the invention better implementation scheme, in addition to this, the present invention can also be the other way, on the premise of not out of the present invention idea any obvious replacement within the scope of protection of the present invention.

1. An oil acid value neutralization and sterilization calcium formula, including by weight as follows:
minerals 0.5-1.5 parts
calcium carbonate powder 7-12 parts
calcium supplements 18-22 parts
silica 8-12 parts
far infrared powder 22-28 parts
negative ion powder 23-27 parts
silicon potting compound 8-12 parts

2. According to claim 1, a kind of oil acid value neutralization and sterilization formula, including by weight as follows:
minerals 0.8-1.2 parts
calcium carbonate powder 9-11 parts
calcium supplements 19-21 parts
silica 9-11 parts
far infrared powder 24-26 parts
negative ion powder 24-26 parts
silicon potting compound 9-11 parts

3. According to claim 1, a kind of oil acid value neutralization and sterilization calcium, further comprising a mineral powder selected from potassium, magnesium, sodium, calcium, selenium and iron, or a combination of one or more of the powders.

4. According to claim 1, a kind of oil acid value neutralization and sterilization formula further comprising far infrared powder added to the raw material for the tourmaline powder.

5. According to claim 1, a kind of oil acid value neutralization and sterilization formula further comprising negative ion powder, electrical stone powder, and the combination of lanthanide or electrical stone powder and the combination of rare earth elements.

6. According to claim 1, a kind of oil acid value neutralization and sterilization calcium formula, further comprising calcium supplements including by weight as follows:
Pearl 3-7 parts
mother-of-pearl 8 -12 parts
red coral 2-3 parts
oyster shell 20-30 parts
clam shells 35-55 parts
giant Clam shells 5-10 parts

7. According to claim 6, a kind of oil acid value neutralization and sterilization calcium, whose character is: calcium supplements including weight of the raw materials as follows
pearl 4-6 parts
mother-of-pearl 9-11 parts
red coral 2.2-2.8 parts
oyster shell 22-28 parts
clam shells 40-50 parts
giant clam shell 6-9 parts

8. A method for making the formula of claim 7, with the following steps:
A, cleaning: to selected raw materials, and adopt the way of high pressure sand blast remove dirt from the surfaces of the raw material;
B, then primary grinding into 200-400 micron particles;
C, then heating in an inert gas to decompose after primary grinding;
D, then again grinding the resulting particles into 30-50 micron particles;
E, nanometer lapping: grinding particle into 0.1-1 nm nano particles;
F, mixing the nanometer particles according to the desired weight ratios, to produce calcium supplements.

9. According to step C of claim 8, as applied to pearl, first heat up to 400-600° C. heat for 1.5 to 2.5 h, then heat up to 800-1000° C. heating for 0.5 -1.5 h.
when processing mother of pearl, first heat up to 800-1000° C., heat for 4.5 to 5.5 h, then heat up to 1700-1900° C. for 4-5 h;
when processing red coral, first heat up to 1000-1200° C. heat for 6.5 to 7.5 h, then heat up to 1600-1800° C. heating 4.5 to 5.5 h;
when processing oyster shells first heat at 700-900° C. heat for 2 to 3 h, then heat at 1600-1800° C. heat for 1-2 h;
when processing clam shells, first heat at 500-700° C. heat for 2.5 to 3.5 h, then heat at 1700-1900° C. for 1.5-2.5 h;
when processing giant clam shell, first heat at 600-800° C. heat for 3-4 h, then heat at 1800-2000° C. for 0.8 -1.2 h

10. According to claim 1 a kind of oil acid value neutralization and sterilization calcium, whose character is: the oil acid value neutralization and sterilization calcium described in honeycomb.
